(19) United States
(12) Patent Application Publication
(10) Pub. No.: US 2024/0326755 A1
(43) Pub. Date: Oct. 3, 2024

(54) REINIGUNGSSYSTEM FÜR EIN ZUMINDEST ZEITWEISE AUTONOM OPERIERENDES FAHRZEUG

(71) Applicant: Robert Bosch GmbH, Stuttgart (DE)

(72) Inventor: Michael Schaeuble, Vaihingen An Der Enz (DE)

(21) Appl. No.: 18/619,381

(22) Filed: Mar. 28, 2024

(30) Foreign Application Priority Data
Mar. 31, 2023 (DE) 102023203007.1

(51) Int. Cl. B60S 1/56

(52) U.S. Cl. CPC B60S 1/56

(57) ABSTRACT

The present invention relates to a cleaning system (10) for a vehicle (100) operating at least temporarily autonomously, comprising at least one cleaning unit (12) set up to clean a surface (14) of the vehicle (100), and a control unit (16), wherein the control unit (16) is set up to receive and/or ascertain at least one driving situation information in an autonomous operation of the vehicle, wherein the control unit (16) is set up to receive and/or ascertain at least one environmental information of the vehicle (100), and wherein the control unit (16) is set up to control the cleaning of the cleaning unit (12) on the basis of the driving situation information and the environmental information.

### BACKGROUND

The present invention relates to a cleaning system for an at least temporarily autonomously operating vehicle and to a vehicle.

There are currently a plurality of different solutions for cleaning surfaces in vehicles. Due to the increasing number of surfaces to be cleaned on the vehicle and their sensors, the demand for cleaning liquid kept in stock is continuously increasing.

Continuous weight reduction in the vehicle sector to reduce consumption and increasing competition are putting pressure on costs, resulting in greater demand for cheaper and more efficient vehicle components.

### SUMMARY

The cleaning system according to the invention for an at least temporarily autonomously operating vehicle has the advantage over the known system that a cleaning process can be further optimized with the aid of the driving situation information and the environmental information of the vehicle, which can have a positive effect on the consumption of cleaning agents. Another advantage of the cleaning system is that a cleaning process can be started preventively using the driving situation information and the environmental information and/or a protective film can be applied to a surface to be cleaned, such as a sensor surface.

According to the invention, this is achieved by the cleaning system for an at least temporarily autonomously operating vehicle having at least one cleaning unit set up to clean a surface of the vehicle. Furthermore, the cleaning system comprises a control unit, wherein the control unit is set up to receive and/or ascertain at least one driving situation information in an autonomous operation of the vehicle, wherein the control unit is set up to receive and/or ascertain at least one environmental information of the vehicle. Furthermore, the control unit is set up to control the cleaning of the cleaning unit based on the driving situation information and the environmental information.

In other words, the cleaning system is preferably able to use the control unit to adapt and/or preventively clean the surface using the cleaning unit based on driving information such as an overtaking maneuver and environmental information such as the amount of precipitation. For example, the cleaning unit is set up to use a cleaning agent such as washing water or a pressurized gas to clean a surface, which is in particular a sensor surface. The control unit can be set up to receive the driving situation information, in particular from a network memory and/or a cloud service, or to ascertain it using at least one sensor, in particular on the vehicle. The control unit can also be set up to retrieve the environmental information from a network server and/or a cloud service, wherein the sensor control unit can also be set up to record the environmental information on the vehicle, in particular by means of a sensor, such as a precipitation sensor.

The dependent claims disclose preferred embodiments of the invention.

Preferably, the control unit is set up to ascertain, based on the driving situation information in autonomous operation of the vehicle and the environmental information from a plurality of surfaces, a surface of the vehicle to be cleaned on which soiling occurs depending on the driving situation and depending on at least one environmental influence.

One advantage of this embodiment is that, based on the driving information and the environmental information, a surface to be cleaned is selected and cleaned instead of cleaning all of the plurality of surfaces on the vehicle. This reduces the consumption of cleaning agents.

The control unit is also preferably set up to adapt the cleaning of the cleaning unit based on the surface to be cleaned using the driving situation information and/or the environmental information.

One advantage of this embodiment is that the available driving situation information and the environmental information can be used in particular to adapt the frequency and/or intensity of a cleaning process of the cleaning unit, so that the surface to be cleaned can be cleaned depending on the driving situation information and/or the environmental information.

Further preferably, the vehicle has a first vehicle side with a first plurality of surfaces to be cleaned and a second vehicle side with a second plurality of surfaces to be cleaned, wherein the control unit is set up to check whether the surface to be cleaned is on the first vehicle side and/or on the second vehicle side, wherein the cleaning unit is set up to at least partially clean all surfaces of the plurality of surfaces on the first vehicle side or the second vehicle side by the cleaning unit based on the check.

One advantage of this embodiment is that, for example, when a passing vehicle is overtaking, the side of the vehicle on which the other vehicle is overtaking can be cleaned in relation to the vehicle with the cleaning system. This can significantly reduce the build-up of soiling, which can be caused in particular by passing vehicles, and also save on cleaning agents. For example, a first vehicle side has three parking sensors and the second vehicle side has another three parking sensors. During the overtaking maneuver of the passing vehicle, which drives past the first vehicle side, the vehicle information and the environmental information can be used to ascertain that one of the three parking sensors on the first side should be cleaned. The control unit can recognize that it is advantageous for all parking sensors on the first side to be cleaned because the passing vehicle is carrying out an overtaking maneuver. Another preferred feature is that the vehicle also has a third and fourth vehicle side, each with a plurality of surfaces to be cleaned, so that all sides of a vehicle can be cleaned with this function.

Preferably, the control unit is set up to adapt an intensity and/or a duration of the cleaning of the cleaning unit based on the at least one driving situation information and/or the at least one environmental information.

An advantage of this embodiment is that the cleaning of the surface can be adapted for all surfaces on the vehicle using the driving situation information and/or the environmental information. For example, the driving situation information contains information that a road surface is causing soiling or environmental information that a quantity of precipitation is raining down on the vehicle. The intensity and duration of cleaning of the cleaning unit can therefore be adapted based on this information. Furthermore, a type of cleaning of the cleaning unit can preferably also be adapted so that, for example, compressed air is preferably applied to the surface of the vehicle in the event of precipitation.

Preferably, the control unit is set up to predict potential soiling of the vehicle's surfaces based on the driving situation information and the environmental information.

An advantage of this embodiment is that a degree and type of soiling of the surface can be predicted using the driving situation information and the environmental information. For example, the driving situation information may contain the information that the road condition is poor, so that a plurality of soiling is to be expected. The environmental information, for example, can comprise the information that precipitation is present. For example, sludge that is softened by rain can be applied to the surface using a combination of cleaning or washing water and compressed air in order to clean the soiling from the surface as efficiently as possible.

The control unit is also preferably set up to preventively activate the cleaning of the cleaning unit based on the potential soiling in order to reduce the build-up of potential soiling.

One advantage of this embodiment is that the preventive activation of the cleaning unit can be used to apply a kind of protective film or similar to the surface.

Further preferably, the cleaning unit is set up to apply at least one fluid, wherein the cleaning unit is set up to apply a fluid protection based on the potential soiling on the surface.

One advantage of this embodiment is that, for example, a fluid such as washing water is applied to the surface, in particular a sensor surface. The fluid protection can reduce the adhesion of soiling, such as dust or similar, or remove it directly from the surface.

Preferably, the control unit is set up to adapt the fluid protection based on at least one environmental factor.

An advantage of this embodiment is that the fluid protection can be adapted based on an environmental factor, so that, for example, if the environmental factor is precipitation, the fluid protection is formed by compressed air, for example, instead of washing water.

The control unit is also preferably set up to ascertain the environmental factor, in particular based on at least one amount of precipitation, a vehicle speed of the vehicle, and/or a position of the surface on the vehicle.

An advantage of this embodiment is that the environmental factor can be ascertained specifically for a surface or for a sensor surface, so that the type or amount of fluid protection applied by the cleaning unit can be adapted accordingly. For example, the surface is a parking sensor close to the ground on the vehicle, so that the fluid protection can preferably be formed from a combination of cleaning agents such as washing water and/or compressed air.

Preferably, the driving situation information comprises at least one driving situation selected from the group: an upcoming driving situation, an overtaking maneuver, in particular of another vehicle, a traffic volume, a driving behavior, in particular of other vehicles, at least one vehicle driving up and/or oncoming.

The driving situation information can be determined in particular by means of a sensor of the cleaning system or the vehicle in the vehicle. The cleaning system can also preferably be set up to retrieve driving situation information, in particular by means of a cloud service or an internet connection.

Preferably, the environmental information comprises at least one environmental factor selected from the group comprising a driving speed of the vehicle, an ambient temperature of the vehicle, an amount of precipitation, a filling level of the at least one cleaning medium of the cleaning unit, a type of soiling of the surface, and/or a road condition.

A further aspect of the invention relates to a method for cleaning a surface of an at least temporarily autonomously operating vehicle, in particular by means of a cleaning system as described above and below, comprising the steps of:
receiving and/or ascertaining at least one piece of driving situation information in autonomous operation of the vehicle,
receiving and/or ascertaining at least one environmental information of the vehicle, and
control the cleaning of the surface based on the driving situation information and the environmental information.

A further aspect of the invention relates to a vehicle comprising a cleaning system as described above and below and at least one surface, in particular a sensor surface.

### BRIEF DESCRIPTION OF THE DRAWINGS

In the following, exemplary embodiments of the invention are described in detail with reference to the accompanying drawing. The drawings show:

FIG. 1 a cleaning system according to one embodiment,

FIG. 2 a vehicle according to one embodiment, and

FIG. 3 a flow chart illustrating the steps of the method according to one embodiment.

### DETAILED DESCRIPTION

Preferably, all the same elements, units, and/or systems are provided with the same reference signs in all the figures.

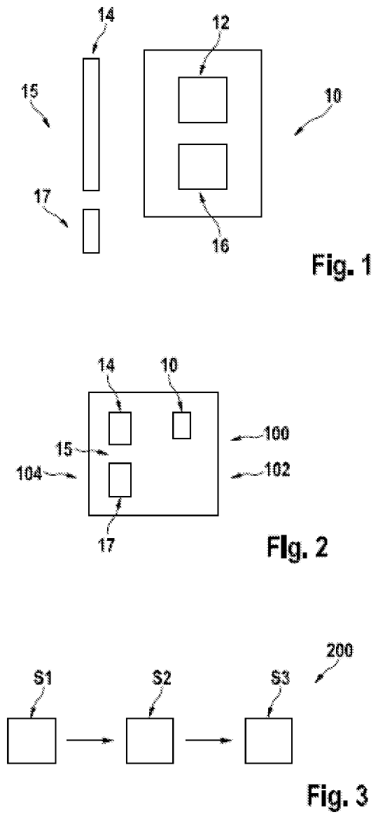

FIG. 1 shows a cleaning system 10.

The cleaning system 10 comprises a cleaning unit 12, which is set up to clean a surface 14, in particular by means of a cleaning agent.

Furthermore, the cleaning system 10 comprises a control unit 16. The control unit 16 is set up to receive and/or ascertain at least one driving situation information in an autonomous operation of the vehicle 100, wherein the control unit 16 is set up to receive and/or ascertain at least one environmental information of the vehicle 100, wherein the control unit 16 is set up to control the cleaning of the cleaning unit 12 on the basis of the driving situation information and the environmental information.

Further preferably, the control unit 16 is set up to ascertain, based on the driving situation information in autonomous operation of the vehicle 100 and the environmental information from a plurality of surfaces 15, a surface 17 of the vehicle 100 to be cleaned, on which soiling occurs depending on the driving situation and depending on at least one environmental influence.

FIG. 2 shows a vehicle 100 according to one embodiment.

The vehicle 100 has a first vehicle side 102 and a second vehicle side 104. Furthermore, the vehicle 100 has a cleaning system 10 as described above and below. The vehicle 100 also has a surface 14. Furthermore, the vehicle 100 has a plurality of surfaces 15. The control unit 16 of the cleaning system 10 can be set up to ascertain a surface 17 to be cleaned from the plurality of surfaces 15 based on the environmental information and the driving situation information.

FIG. 3 shows a flowchart illustrating steps of the method 200. Preferably, the method 200 comprises the step of receiving and/or ascertaining S1 at least one driving situation information in an autonomous operation of the vehicle 100. Furthermore, the method 200 preferably comprises the step of receiving and/or ascertaining S2 at least one environmental information of the vehicle 100. Further preferably, the method 200 comprises the step S3 of controlling the cleaning of the surface 14 based on the driving situation information and the environmental information.

1. A cleaning system (10) for an at least temporarily autonomously operating vehicle (100):
at least one cleaning unit (12) configured to clean a surface (14) of the vehicle (100), and
a control unit (16),
wherein the control unit (16) is configured to receive and/or determine driving situation information in an autonomous operation of the vehicle,
wherein the control unit (16) is configured to receive and/or determine an environmental information item of the vehicle (100), and
wherein the control unit (16) is configured to control the cleaning of the cleaning unit (12) based on the driving situation information and the environmental information.

2. The cleaning system (10) according to claim 1, wherein the control unit (16) is configured to determine, based on the driving situation information in autonomous operation of the vehicle and the environmental information, a surface (17) of the vehicle (100) to be cleaned from a plurality of surfaces (15), on which a soiling occurs depending on the driving situation and depending on at least one environmental influence.

3. The cleaning system (10) according to claim 2, wherein the control unit (16) is configured to adapt the cleaning of the cleaning unit (12) based on the surface (17) to be cleaned by means of the driving situation information and/or the environmental information.

4. The cleaning system (10) according to claim 2, wherein the vehicle (100) has a first vehicle side (102) with a first plurality of surfaces to be cleaned and a second vehicle side (104) with a second plurality of surfaces to be cleaned, wherein the control unit (10) is configured to check whether the surface (17) to be cleaned is on the first vehicle side (102) or on the second vehicle side (104), wherein the cleaning unit (12) is configured to at least partially clean all surfaces of the plurality of surfaces on the first vehicle side (102) or the second vehicle side (104) by the cleaning unit (12) based on the check.

5. The cleaning system (10) according to claim 1, wherein the control unit (16) is configured to adapt an intensity and/or a duration of the cleaning of the cleaning unit (12) based on the at least one driving situation information and/or the at least one environmental information.

6. The cleaning system (10) according to claim 1, wherein the control unit (16) is configured to predict a potential soiling of the surface (14) of the vehicle (100) based on the driving situation information and the environmental information.

7. The cleaning system (10) according to claim 6, wherein the control unit (16) is configured to preventively activate the cleaning of the cleaning unit (12) based on the potential soiling in order to reduce adhesion of the potential soiling.

8. The cleaning system (10) according to claim 6, wherein the cleaning unit (12) is configured to apply at least one fluid, wherein the cleaning unit (12) is configured to apply a fluid protection based on the potential soiling on the surface (14).

9. The cleaning system (10) according to claim 8, wherein the control unit (16) is configured to adapt the fluid protection based on at least one environmental factor.

10. The cleaning system (10) according to claim 9, wherein the control unit (16) is configured to determine the environmental factor based on an amount of precipitation, a vehicle speed of the vehicle (100), and/or a position of the surface (14) on the vehicle (100).

11. The cleaning system (10) according to claim 1, wherein the driving situation information comprises at least one driving situation selected from the group consisting of: an upcoming driving situation, an overtaking maneuver, a traffic volume, and a driving behavior of other vehicles.

12. The cleaning system (10) according to claim 1, wherein the environmental information comprises at least one environmental factor selected from the group consisting of: a driving speed of the vehicle (100), an ambient temperature of the vehicle (100), an amount of precipitation, a filling level of the a cleaning medium of the cleaning unit (12), a type of soiling of the surface, and a road condition.

13. A method (200) for cleaning a surface (14) of an at least temporarily autonomously operating vehicle (100), the method comprising:
receiving and/or determining (S1) at least one piece of driving situation information in autonomous operation of the vehicle (100),
receiving and/or determining (S2) at least one environmental information of the vehicle (100), and
controlling (S3) the cleaning of the surface (14) based on the driving situation information and the environmental information.

14. A vehicle (100) comprising a cleaning system (10) according to claim 1 and a sensor surface.
